(19) United States
(12) Patent Application Publication
(10) Pub. No.: US 2002/0171975 A1
(43) Pub. Date: Nov. 21, 2002

(54) Writing element with no return path

(76) Inventors: Martin L. Plumer, Bloomington, MN (US); Johannes van Ek, Minnetonka, MN (US); Vee S. Kong, Richfield, MN (US); Nurul Amin, St. Paul, MN (US); Ned Tabat, Chanhassen, MN (US); Richard P. Michel, Minneapolis, MN (US)

Correspondence Address: Brian D. Kaul, WESTMAN CHAMPLIN & KELLY, International Centre - Suite 1600, 900 South Second Avenue, Minneapolis, MN, 55402-3319, US

(21) Appl. No.: 10/039,207

(22) Filed: Jan. 4, 2002

Related U.S. Application Data
(60) Provisional application No. 60/291,297, filed on May 15, 2001.

(51) Int. Cl. G11B 5/127

(52) U.S. Cl. 360/125

(57) ABSTRACT

A writing element includes a writing pole, a conducting coil and an insulating material. The writing pole includes a pole tip and extends therefrom to a back gap region. The conducting coil includes coil segments positioned adjacent and transverse to the writing pole. The coil segments are adapted to produce magnetic signals that orient magnetization vectors at the pole tip of the writing pole in a desired direction. The insulating material is formed between the writing pole and the coil segments. Magnetic signals do not conduct to the back gap region through a return pole element.

### CROSS-REFERENCE TO RELATED APPLICATION

This application claims priority from U.S. Provisional Application 60/291,297 filed on May 15, 2001 for inventors Martin L. Plumer; Johannes van Ek; Vee S. Kong; Nurul Amin; Ned Tabat; and Richard P. Michel and entitled “THIN FILM WRITE HEADS WITH NO RETURN PATH.”

### FIELD OF THE INVENTION

The present invention relates generally to disc drive storage systems. More particularly, but not by limitation, the present invention relates to writing elements for use in a read/write head having no return path.

### BACKGROUND OF THE INVENTION

Disc drives are the primary devices employed for mass storage of computer programs and data. Disc drives typically use rigid discs, which are coated with a magnetizable medium to form a recording layer in which data can be stored in a plurality of circular, concentric data tracks. Typical read/write heads include separate read and write head portions. One advantage to this configuration is that the read and write heads can be optimized for the particular task they are to perform.

The read head typically includes a magnetoresistive or a giant magnetoresistive read element that is adapted to read magnetic flux transitions recorded to the tracks which represent the bits of data. The magnetic flux from the disc surface causes a change in the electrical resistivity of the read element, which can be detected by passing a sense current through the read element and measuring a voltage across the read element. The voltage measurement can then be decoded to determine the recorded data.

The write head includes an inductive writing element for generating a magnetic field that aligns the magnetic moments of the recording layer to represent the desired bits of data. Magnetic recording techniques include both longitudinal and perpendicular recording. Perpendicular recording is a form of magnetic recording in which magnetic moments representing bits of data are oriented perpendicularly to the surface of the recording layer of the recording medium, as opposed to longitudinally along a track of the medium as in the more traditional longitudinal recording technique. Perpendicular recording offers advantages over longitudinal recording, such as significantly higher areal density recording capability.

Designers of writing elements continuously face a dilemma of providing high performance writing elements, which can be easily manufactured at a low cost. Unfortunately, conventional high performance writing elements require the precise formation of several magnetic components of the writing element. These include a writing pole, a return pole, and a back gap “via,” which connects the writing pole to the return pole to complete a return path through which magnetic signals are conducted through the writing element. Additionally, a conductive coil, which is responsible for generating the magnetic signals, must be formed among these magnetic components. The processing techniques that are used to form the components of the writing element include photo-patterning, magnetic material deposition, etching, milling and other processes. These thin-film processing techniques are complex as well as sensitive to process variations, which results in increased costs due to a high percentage of defectively produced components.

In addition to making the manufacture of the writing element more complex, the multiple magnetic components of the writing element add significantly to the amount of magnetic material present in the writing element. Some of these magnetic components, such as the return pole, are intended to benefit the operation of the adjacent read element by providing a magnetic “shield” to protect the read sensor from stray magnetic fields. However, contradictory to conventional thought, it is believed that these magnetic components can present substantial adverse effects that could outweigh their potential benefit, especially in light of the increased manufacturing complexity that results from including them in the writing element.

In particular, the magnetic material operates to concentrate and magnify the stray magnetic fields, which can result in unintentional erasing of data recorded on the recording medium. For example, stray magnetic fields that magnetize the soft magnetic underlayer of a perpendicular recording medium can produce magnetic flux that fringes up into the return pole tip. The return pole tip conducts the magnetic flux to the writing pole tip through the return path, which responsively produces a strong magnetic field that can cause unintentional data erasure or degradation in the recording layer of the recording medium. A similar result can also occur due to the collection and concentration of stray magnetic fields, generated during normal disc drive operation, in the return pole that are conducted to the writing pole tip through the return path.

The performance of a writing element is generally measured by the areal density at which it is capable of writing data. The areal density is defined as the number of bits per unit length along a track (linear density in units of bits per inch) multiplied by the number of tracks available per unit length in the radial direction of the disc (track density in units of track per inch or TPI). Accordingly, some of the important characteristics of the writing element are the track width within which the writing element can write bits of data and the linear density at which the writing element can write bits of data along a given track. The track width of the writing element is generally determined by a width of the pole tip of the writing pole. The linear density of a perpendicular writing element is determined, in part, by the thickness or height of the pole tip. Writing element designers have worked to optimize these parameters of writing elements in an effort to meet the never-ending demands for higher areal density recording capability.

In addition to providing high areal density capability, it is also important that the writing element be capable of writing data at a high rate. High speed reading and writing are always desirable to improve disc drive performance. However, this characteristic of the writing element must continue to improve to meet the demands imposed by increased linear density recording capabilities of the writing element, which will require data to be recorded at a faster rate for a given angular velocity of the recording medium. Unfortunately, the responsiveness of the writing pole of the writing element is slowed by adjacent magnetic components, such as the return pole and back gap. Although this property of conventional writing elements has generally taken a back seat to the optimization of the writing pole tip dimensions, it plays an important role in the overall performance of the disc drive.

There is a continued demand for improvements to writing elements for use in drive storage systems. These desired improvements include easier manufacturability, lower likelihood of producing unintentional data-erasing fields, and faster responsiveness. Embodiments of the present invention provide a writing element with these and other improvements and offer other advantages over the prior art.

### SUMMARY OF THE INVENTION

The present invention is directed to a writing element for recording data to a hard magnetic layer of a rotating disc. The writing element includes a writing pole, a conducting coil and an insulating material. The writing pole includes a pole tip and extends therefrom to a back gap region. The conducting coil includes coil segments positioned adjacent and transverse to the writing pole. The coil segments are adapted to produce magnetic signals that orient magnetization vectors at the pole tip of the writing pole in a desired direction. The insulating material is formed between the writing pole and the coil segments. The writing element is free of magnetic return pole elements that form a return path through which the magnetic signals are conducted to the back gap region.

Other features and benefits that characterize embodiments of the present invention will be apparent upon reading the following detailed description and review of the associated drawings.

### BRIEF DESCRIPTION OF THE DRAWINGS

FIG. 1 is an isometric view of a disc drive.

FIG. 2 is a cross-sectional view of a read/write head in accordance with the prior art.

FIG. 3 is a simplified layered diagram of the prior art read/write head of FIG. 2 as viewed from the recording medium.

FIGS. 4 and 5 are a simplified cross-sectional views of a read/write head including a read element in accordance with embodiments of the present invention.

FIG. 6 is a simplified top view of a conductive coil in accordance with an embodiment of the invention.

### DETAILED DESCRIPTION OF ILLUSTRATIVE EMBODIMENTS

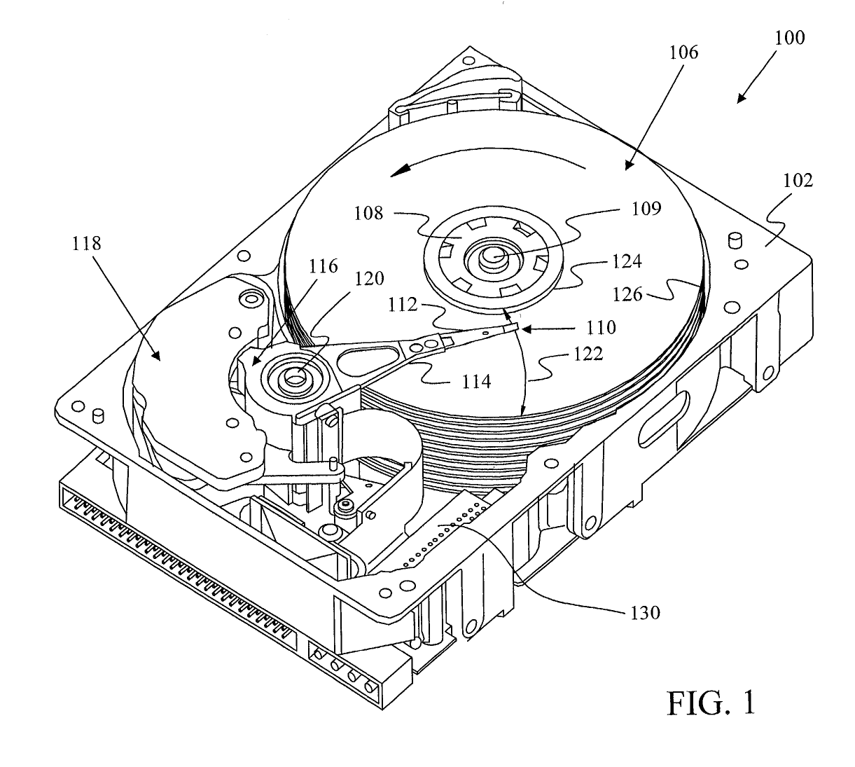

FIG. 1 is an isometric view of a disc drive 100 in which embodiments of the present invention are useful. Disc drive 100 includes a housing with a base 102 and a top cover (not shown). Disc drive 100 further includes a disc pack 106, which is mounted on a spindle motor (not shown) by a disc clamp 108. Disc pack 106 includes a plurality of individual discs, which are mounted for co-rotation about central axis 109. Each disc surface has an associated disc head slider 110 which is mounted to disc drive 100 for communication with the disc surface. In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126. Voice coil motor 118 is driven by servo electronics 130 based on signals generated by heads 110 and a host computer (not shown).

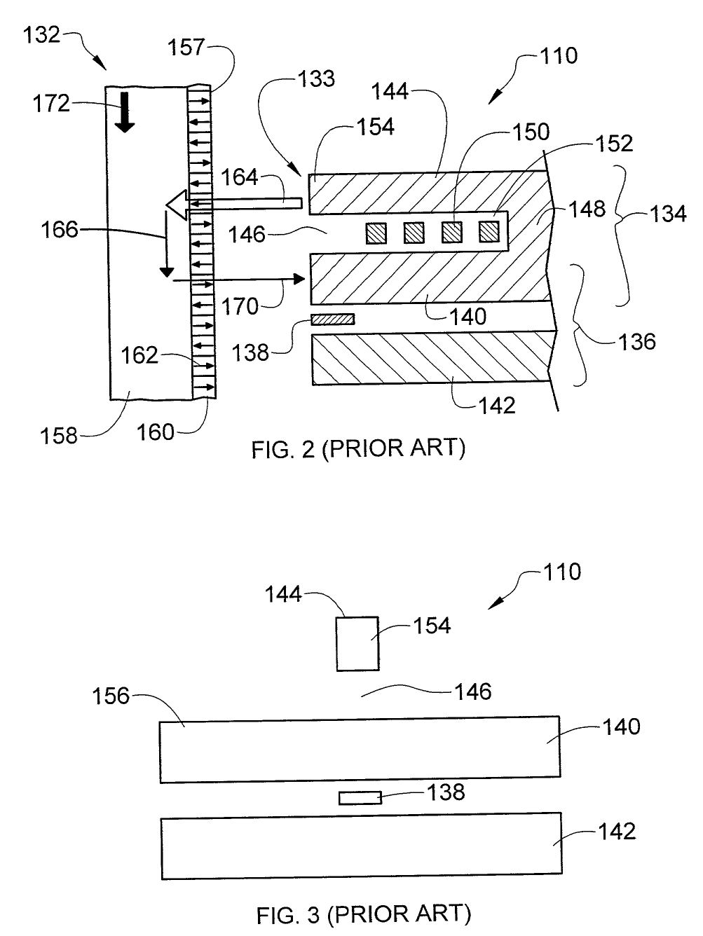

A side cross-sectional view of a read/write head 110 in accordance with the prior art as shown in FIG. 2. FIG. 3 is a simplified layered diagram of the read/write head 110 of FIG. 2 as viewed from a disc 132 and illustrates the location of a plurality of significant elements as they appear along an air bearing surface (ABS) 133 of head 110. In FIG. 3, all spacing and insulating layers are admitted for clarity. Read/write head 110 includes a writing element 134 and a reading element 136. Reading element 136 of head 110 includes a read sensor 138 that is spaced between a return pole 140, which operates as a top shield, and a bottom shield 142. The top and bottom shields operate to isolate the reading element from external magnetic fields that could affect its sensing bits of data that have been recorded on disc 132.

Typical perpendicular and longitudinal writing elements, such as writing element 134, include a main or writing pole 144 and return pole 140. The writing and return poles 144 and 140 are separated by a writer gap 146. Writing pole 144 and return pole 140 are connected at a back gap “via” 148 to form a C-shaped magnetic core. A conductive coil 150 extends between writing pole 144 and return pole 140 and around back gap 148. An insulating material 152 electrically insulates conductive coil 150 from writing and return poles 144 and 140. Writing and return poles 144 and 140 include writing and return pole tips 154 and 156, respectively, which face disc surface 157 and form a portion of the ABS 133 of disc head slider 110.

A magnetic circuit is formed in writing element 134 by writing and return poles 144 and 140, and back gap 148. For perpendicular recording, the magnetic circuit further includes a soft magnetic layer 158 of disc 132, which underlays a hard magnetic or recording layer 160. Recording layer 160 includes vertical magnetic moments 162, each of which represent a bit of data in accordance with their up or down orientation. In operation, an electrical current is caused to flow in conductor coil 150, which induces a magnetic field that is conducted through the magnetic circuit. The magnetic circuit causes the magnetic field to travel through the writing pole tip 154 and recording layer 160 of the recording medium as indicated by arrow 164. Next, the magnetic field is directed through soft magnetic layer 158 of the recording medium, as indicated by arrow 166, and then back through recording layer 160 through return pole tip 156 of return pole 140, as indicated by arrow 170. Finally, the magnetic signal is conducted back to writing pole 144 through a return path that includes writing pole 140 and back gap 148.

The magnetic circuit for longitudinal recording does not include soft magnetic layer 158 of disc 132. Instead, the recording medium includes a recording layer (not shown) having horizontally aligned magnetic moments. Magnetic flux that fringes across writer gap 146 from writing pole 144 to return pole 140, orients the magnetic moments below the writer gap 146 in the direction of the magnetic field. Return pole 140 receives magnetic signals from writing pole 144 and, along with back gap 148, provides a return path to conduct them back to writing pole 144.

The above-described conventional prior art writing elements are expensive to manufacture due to their complexity as a result of the multiple magnetic components. In addition, the substantial magnetic material that is present in these writing elements operates to concentrate and magnify stray magnetic fields, which can result in the undesirable erasing of data recorded on the recording medium. Furthermore, the substantial magnetic material adversely affects the responsiveness of the writing element.

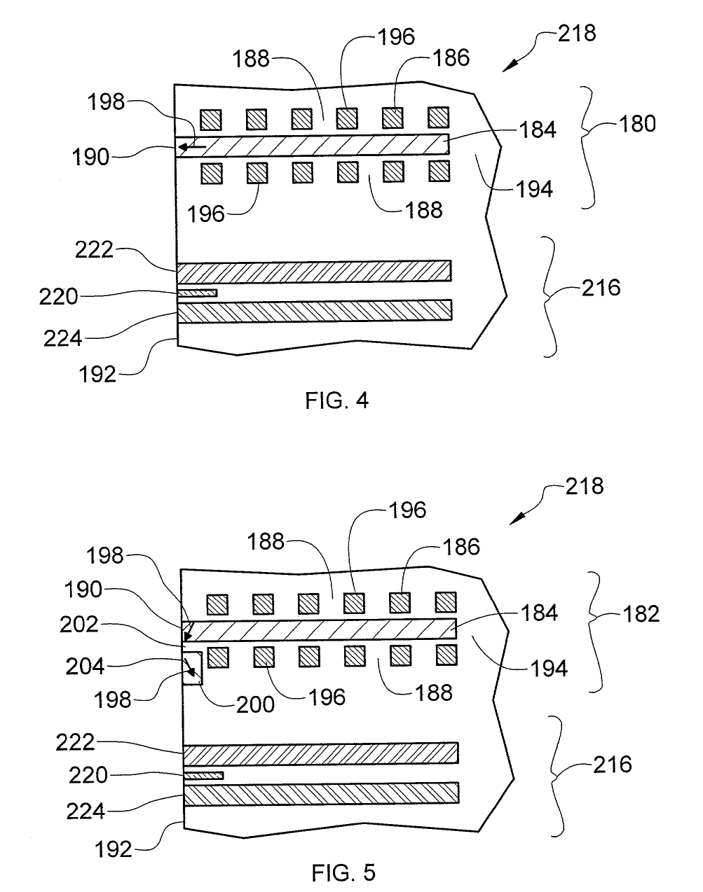

The present invention is directed to a writing element for use with a disc drive storage system (such as disc drive 100 of FIG. 1) that provides many advantages over prior art writing element designs including reduced manufacturing costs, reduced likelihood of unintentional data erasure, and improved responsiveness. FIGS. 4 and 5 respectively show side crosssectional views of writing elements 180 and 182 in accordance with perpendicular and longitudinal recording embodiments of the invention. To simplify the discussion of the invention, many of the elements in the figures that are substantially the same, are identified by the same number or label.

Writing elements 180 and 182 each include a writing pole 184, a conductive coil 186, and an insulating material 188 that insulates writing pole 184 from conductive coil 186. Writing pole 184 includes a pole tip 190 at an air bearing surface (ABS) 192. Writing pole 184 extends substantially perpendicularly from ABS 192 toward a back gap region 194. Conductive coil 186 includes coil segments 196 that are positioned adjacent and transverse to writing pole 184. Some of the coil segments are positioned proximate to ABS 192. A current flowing in opposite directions in opposing coil segments 196, produces magnetic signals which control an orientation of magnetization vectors 198 of writing pole 184. Writing pole 184 is formed of a soft or magnetically permeable material such as cobalt-iron (CoFe), cobalt-nickel-iron (CoNiFe), nickel-iron (NiFe), cobalt (Co), or other suitable soft magnetic material. Conducting coil 186 can be formed of copper (Cu) or other conductive material. Insulating material 188 can be formed of tantalum (Ta), tungsten (W), or other suitable insulating material.

Writing element 180 operates with a perpendicular recording medium, such as a disc 132 (FIG. 2), having a hard recording layer 160 overlaying a soft magnetic layer 158 to perform the desired perpendicular recording. Magnetic signals generated by conductive coil 186 directs the orientation of magnetization vectors 198 in a desired direction. Soft magnetic layer 158 operates to further assist in the orientation of magnetization vectors 198 in the desired direction and to orient the magnetic moments (such as 162 of FIG. 2) of hard recording layer 162 accordingly.

Writing element 182 includes an auxiliary pole 200 formed of a soft magnetic material that is separated from writing pole 184 by a writer gap 202. Auxiliary pole 200 includes an auxiliary pole tip 204 at ABS 192. Magnetic signals generated by conductive coil 186 produces a fringing magnetic field from writing pole 184 across writer gap 202 to auxiliary pole 200. Auxiliary pole 200 operates in a similar fashion as the soft magnetic underlayer 158 by assisting in the orientation of magnetization vectors 198. The direction of the fringing magnetic field determines the orientation of the magnetic moments of the hard magnetic layer of the recording medium when located in close proximity to pole tips 190 and 204 of writing element 182.

Unlike conventional prior art writing elements, such as 134 of FIG. 2, writing elements 180 and 182 do not includes magnetic return pole elements that form a return path along which magnetic signals can be conducted to back gap region 194. It has been determined using computer modeling (Micromagnetic and Finite-Element-Method modeling) that a return path is not required to satisfy Ampere's Law. However, the elimination of the return path reduces the amount of soft magnetic material that can concentrate the magnetic signals generated by conducting coil 186 and conduct them through writing pole 184. As a result, the efficiency of writing elements 180 and 182 will be reduced.

Fortunately, the reduced efficiency can be compensated for through the addition of more coil segments 196 placed in close proximity to writing pole 184, such as above and below writing pole 184 as shown in FIGS. 4 and 5. Additionally, the placement of coil segments 196 close to writing pole tip 190 and ABS 192 further enhances the strength of the magnetic field at pole tip 190 where the “recording” will occur. Due to structural constraints, it is preferable that coil segments be spaced at least 1micrometer from ABS 192.

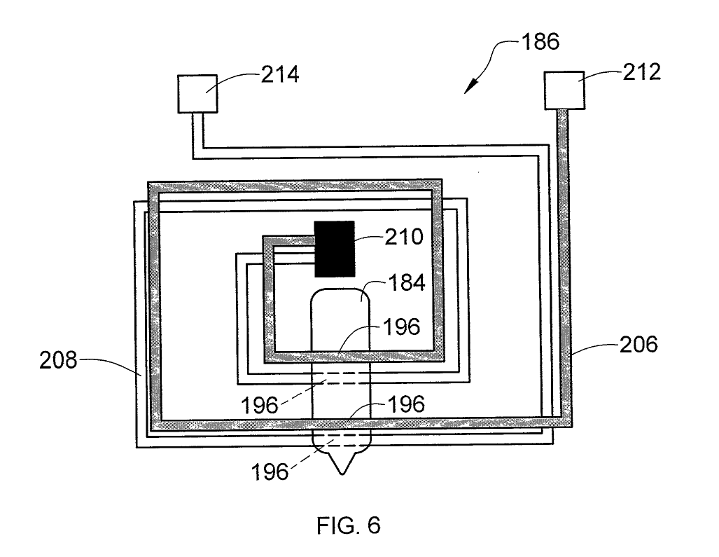

In accordance with one embodiment of the invention, conducting coil 186 wraps around writing pole 184 in a helical fashion. FIG. 6 is a simplified illustration of another embodiment of conducting coil 186. This “double pancake” embodiment of conducting coil 186 includes first and second coil layers 206 and 208 respectively positioned above and below writing pole 184. First and second coil layers 206 and 208 are connected at a vertical “via” 210 and receive a current regulated by circuitry (not shown) at terminals 212 and 214. The current flows from the circuitry to terminal 212 through first coil layer 206 to second coil layer 208 through vertical “via” 210 and finally back to the circuitry through terminal 214. Such a current would flow in one direction through coil segments 196 of first coil layer 206 and in the opposite direction through coil segments 196 of second coil layer 208 to produce the desired magnetic signals. Note that the number of coil segments 196 that are shown in FIG. 6 have been limited to simplify the illustration of coil 186.

Writing elements 180 and 182 can be combined with a conventional read element 216 to form a read/write head 218, as shown in FIGS. 4 and 5. Read element 216 includes a read sensor 220 sandwiched between top and bottom shields 222 and 224, respectively. Unlike conventional read/write heads 218, writing element 180 or 182 does not share a magnetic pole to operate as top shield. Instead, it is desirable that read element 216 be displaced from writing pole 184 by a relatively substantial distance to prevent the conduction of magnetic signals, generated by conducting coil 186, to back gap region 194 of writing elements 180 and 182. To that end, it is preferred that top shield 222 be positioned approximately 4-5micrometers from writing pole 184.

Writing elements 180 and 182 utilize substantially less soft magnetic material that conventional prior art writing elements, such as 134 of FIG. 2. In particular, the amount of soft magnetic material positioned adjacent ABS 192 has been reduced significantly. This reduces the sensitivity of writing elements 180 and 182 and read element 216 to stray magnetic fields that are generated during normal disc drive operation. Additionally, there is a reduced likelihood of unintentional data erasure in response to stray magnetic fields due to the reduction of soft magnetic material in the head. Furthermore, the responsiveness of writing pole 184 is enhanced resulting in improved recording performance.

In summary, the present invention is directed to a writing element (such as 180 and 182) for recording data to a hard magnetic layer (such as 160) of a rotating disc (such as 132). The writing element includes a writing pole (such as 184), a conducting coil (such as 186), and an insulating material (such as 188). The writing pole includes a pole tip (such as 190) and extends therefrom to a back gap region (such as 194). The conductive coil includes coil segments (such as 196) positioned adjacent and transverse to the writing pole. The coil segments are adapted to produce magnetic signals that orient magnetization vectors (such as 198) at the pole tip of the writing pole in a desired direction. The insulating material is positioned between the writing pole and the conductive coil segments. The coil segments are preferably displaced from the pole tip by at least approximately one micrometer. The writing pole is free of return pole elements (such as 140) that form a return path through which the magnetic signals are conducted to the back gap region. In other words, magnetic signals do not conduct to the back gap region through return pole elements.

In accordance with another embodiment of the invention, the writing element includes an auxiliary pole (such as 200) displaced from the gap region and having a pole tip (such as 204) that is separated from the pole tip of the writing pole by a writer gap (such as 202). Components of magnetization vectors at the pole tips of the writing and auxiliary poles are aligned in a direction that is approximately parallel to the recording layer in response to the magnetic signals produced by the conducting coil for longitudinal recording of data in the hard magnetic layer of the disc.

In yet another embodiment of the invention, the conductive coil wraps around the writing pole in a helical fashion. In a “double pancake”embodiment, the conductive coil is formed of first and second coil layers (such as 206 and 208) respectively positioned above and below the writing pole and connected through a vertical “via” (such as 210). The conductive coil can be formed of copper (Cu) or other suitable conductive material.

In accordance with another embodiment, a read/write head is formed that includes the writing element and a read element (such as 216). Read element can include a top shield (such as 222) that is displaced from the writing element. Yet another embodiment is directed to a disc drive storage system (such as 100) that includes the writing element.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the writing element while maintaining substantially the same functionality without departing from the scope and spirit of the present invention.

What is claimed is:

1. A writing element for recording data to a hard magnetic recording layer of a rotating disc, the writing element comprising:
a writing pole having a pole tip and extending therefrom to a back gap region;
a conducting coil having coil segments positioned adjacent and transverse to the writing pole and proximate the pole tip, the coil segments adapted to produce magnetic signals that orient magnetization vectors at the pole tip of the writing pole in a desired direction; and
an insulating material between the writing pole and the coil segments;
wherein the magnetic signals do not conduct to the back gap region through a return pole element.

2. The writing element of claim 1, wherein the conducting coil wraps around the writing pole in a helical fashion.

3. The writing element of claim 1, wherein the conducting coil is formed of first and second coil layers respectively positioned above and below the writing pole and connected through a vertical via.

4. A read/write head including:
the writing element of claim 1; and
a read element having a read sensor sandwiched between top and bottom shields.

5. A disc drive storage system including the writing element of claim 1.

6. The magnetic writing element of claim 1, including an auxiliary pole displaced from the gap region, the auxiliary pole having a pole tip that is separated from the pole tip of the writing pole by a writer gap; wherein components of magnetization vectors at the pole tips of the writing and auxiliary pole are aligned in a direction that is approximately parallel to the hard magnetic layer in response to the magnetic signals produced by the conducting coil for longitudinal recording of data in the hard magnetic layer of the disc.

7. A perpendicular magnetic writing element for recording data to a hard magnetic recording layer, which overlays a soft magnetic layer of a rotating disc, the writing element comprising:
a writing pole having a pole tip and extending therefrom to a back gap region;
a conducting coil having coil segments positioned adjacent and transverse to the writing pole and proximate the pole tip, the coil segments adapted to produce magnetic signals that orient magnetization vectors at the pole tip of the writing pole in a desired direction; and
an insulating material between the writing pole and the coil segments;
wherein the magnetic signals do not conduct to the back gap region through a return pole element.

8. The writing element of claim 7, wherein the conducting coil wraps around the writing pole in a helical fashion.

9. The writing element of claim 7, wherein the conducting coil is formed of first and second coil layers respectively positioned above and below the writing pole and connected through a vertical via.

10. A read/write head including:
the writing element of claim 7; and
a read element having a read sensor sandwiched between top and bottom shields.

11. A disc drive storage system including the writing element of claim 7.

12. A longitudinal magnetic writing element for recording data to a hard magnetic recording layer of a rotating disc, the writing element comprising:
a writing pole having a pole tip at an air bearing surface (ABS) and extending substantially perpendicularly therefrom to a back gap region;
an auxiliary pole displaced from the gap region, the auxiliary pole having a pole tip at the ABS that is separated from the pole tip of the writing pole by a writer gap;
a conducting coil having coil segments positioned adjacent and transverse to the writing pole and proximate the ABS, the coil segments adapted to produce magnetic signals which cooperate to orient components of magnetization vectors at the pole tips of the writing and auxiliary pole in a direction that is approximately parallel to the ABS; and
an insulating material between the writing poles and the coil segments;
wherein the writing element is free of return pole elements that form a return path through which the magnetic signals are conducted to the back gap region.

13. The writing element of claim 12, wherein the conducting coil wraps around the writing pole in a helical fashion.

14. The writing element of claim 12, wherein the conducting coil is formed of first and second coil layers respectively positioned above and below the writing pole and connected through a vertical via.

15. A disc drive storage system including the writing element of claim 12.

16. A read/write head including:
the writing element of claim 12; and
a read element adjacent the ABS and having a read sensor sandwiched between top and bottom shields.

17. A perpendicular magnetic writing element for recording data to a hard magnetic recording layer of a rotating disc, the writing element comprising:
a perpendicular writing means for writing magnetic transitions in the hard magnetic recording layer, wherein magnetic signals do not conduct to the back gap region through a return pole element.; and
a conducting coil having coil segments positioned adjacent and transverse to the perpendicular writing means, the coil segments adapted to produce magnetic signals which cooperate to orient magnetization vectors in the perpendicular writing means in a desired direction.

18. The writing element of claim 17, wherein the perpendicular writing means includes a writing pole having a pole tip and extending therefrom to the back gap region.

19. The writing element of claim 17, including an auxiliary pole displaced from the gap region, the auxiliary pole having a pole tip that is separated from the pole tip of the writing pole by a writer gap; wherein components of magnetization vectors at the pole tips of the writing and auxiliary poles are aligned in a direction that is approximately parallel to the recording layer in response to the magnetic signals produced by the conducting coil.

20. The writing element of claim 17, wherein the conducting coil wraps around the perpendicular writing means in a helical fashion.

21. The writing element of claim 17, wherein the conducting coil is formed of first and second coil layers respectively positioned above and below the perpendicular writing means and connected through a vertical via.

22. A read/write head including:
the writing element of claim 17; and
a read element having a read sensor sandwiched between top and bottom shields.

23. A disc drive storage system including the writing element of claim 17.
